(19) United States
(12) Patent Application Publication
(10) Pub. No.: US 2026/0077549 A1
(43) Pub. Date: Mar. 19, 2026

(54) LINER FOR A CONTAINER

(71) Applicant: RKW SE, Mannheim (DE)

(72) Inventors: Christian REINDL, Oberguenzburg (DE); Florian GLASEDONNER, Babensham (DE); Leonhard MAIER, Babensham (DE)

(73) Assignee: RKW SE, Mannheim (DE)

(21) Appl. No.: 19/109,447

(22) PCT Filed: Aug. 7, 2023
(86) PCT No.: PCT/EP2023/071819

§ 371 Date: Mar. 6, 2025

(30) Foreign Application Priority Data
Sep. 7, 2022 (DE) 102022122730.8

(51) Int. Cl. B29C 48/21; B29K 23/00; B29K 77/00; B29K 105/00

(52) U.S. Cl. CPC B29C 48/21; B29C 2948/92676; B29C 2948/92733; B29C 2948/92771; B29K 2023/0633; B29K 2023/083; B29K 2077/00; B29K 2105/0085; B29K 2995/0007; B29K 2995/0067; B29K 2995/0077; B29K 2995/0097

(57) ABSTRACT

A liner (1) for a container for holding a granulate which has a blowing agent. The liner (1) has at least one polyamide layer (4) which is arranged between two ethylene copolymer layers (2).

### CROSS REFERENCE TO RELATED APPLICATIONS

This application is a 371 National Phase of PCT/EP2023/071819, filed Aug. 7, 2023, which claims priority from German Patent Application No 10 2022 122 730.8, filed Sep. 7, 2022, both of which are incorporated herein by reference as if fully set forth.

### TECHNICAL FIELD

The invention relates to a liner for a container for holding a granulate containing a blowing agent.

### BACKGROUND

A container or receptacle is an object that has a cavity in its interior, which serves in particular to separate its contents from its environment. Some types of container have the option of being sealed. Containers and receptacles are used to keep or store different objects for a certain period of time. However, they can also be used as containers to group or organize piece goods or bulk goods. Another area of application is to protect the contents from external influences or, conversely, to protect the environment from the dangers of the contents during storage and transportation.

Open-top containers are used, for example, in the chemical industry for filling granular substances, whereby an inner liner with a plastic film is intended to prevent the product from escaping from the container and at the same time provide protection against moisture.

An octabin is an octagonal container for the transportation and storage of bulk goods. It is made of sturdy corrugated cardboard and has a base and a removable lid. Its basic dimensions are usually 1200 mm×1200 mm, so that it fits on a Euro pallet. The height can be selected between 800 mm and 2000 mm, depending on requirements. Octabins are mainly used for granulates and other free-flowing products. A thin plastic film, also known as an inlay or liner, can be inserted for dusty goods.

A film-based liner of containers made of cardboard, for example, is usually carried out manually using prefabricated plastic bags. A prefabricated bag or film sack is inserted from above and folded outwards at the top edge of the container to prevent it from being pulled into the container. After the filling process, the film bag is manually detached from the container edge at the top and sealed. Alternatively, there are also sealed film bags that can be filled mechanically via a tube and a tube opening in the film bag.

DE 20 2015 101 558 U1 discloses a tarpaulin for a container which is filled with fine-grained bulk material, in particular plastic granulate, with at least one opening for a suction pipe which can be inserted into the container from above and is connected to a suction device which sucks the fine-grained bulk material out of the container and transports it away. The tarpaulin consists of a flexible sheet and a contour adapted to the top opening of the container, with an edge projecting beyond the shell wall of the container, which is formed elastically or gathered by means of an elastic or non-elastic band and rests against the outer surface of the shell wall of the container in the upper edge area, and in that a closable slot is provided in the flat structure, which slot extends from the edge region in the direction of the center of the opening of the container and can be widened at least in the push-through region of the suction tube in order to accommodate the suction tube.

EP 2 233 283 A2 describes a method for lining the inside of a container open on one side with a plastic film, comprising the following steps: Feeding and positioning a container to be lined at a working position, detecting a container height, providing an expandable tubular film, sealing and cutting off a predetermined length of the tubular film and forming a bag-shaped tubular film section which has a length dependent on the detected container height, meeting the tubular film section and moving it into a transfer position adjacent to a container opening, unwinding a part of the stretched tubular film section, holding a free edge section of the tubular film section and stretching and fitting the edge section over an edge of the container, and unwinding the edge section for contact with an outer wall of the container.

Granular matter, also known as granular medium or granulate, consists of many small, solid particles such as grains or spheres. Examples of this condition are granular materials such as plastic granules and powdery materials.

Plastic granulate is the typical delivery form of thermoplastics from raw material manufacturers for the plastics processing industry. Due to its pourability, it is a bulk material like sand or gravel and therefore just as easy to transport as the latter. Plastic granules are often also referred to as plastic pellets.

However, plastic granulates are usually characterized by special challenges when it comes to handling. For example, a filling process usually leads to electrostatic charging of the liner and the filling equipment, which can only be handled safely with the help of a well thought-out and consistent electrostatic discharge system without creating a major potential hazard for workers in the immediate vicinity of such a filling process. In addition, there are numerous plastic granulates that continue to outgas educts and/or products and/or additives such as blowing agents for a long time after production. The combination of outgassing, possibly explosive substances with the electrostatic charge from the granulate represents a major challenge and an enormous potential hazard for liners that are optimized in terms of their mechanical properties.

### SUMMARY

The object of the present invention is to provide a liner for a container which has sufficient electrostatic dissipative properties and at the same time prevents the passage of outgassing. The liner should also be mechanically suitable filling and emptying granules. In addition, the liner should only allow water vapor to pass through in a very defined area. The liner should be as thin as possible and at the same time puncture-proof

According to the invention, this object is ensured by a liner for a container, a method and a use according to the subsidiary main claims. Preferred variants can be found in the subclaims, the description, the embodiment example and the drawings.

According to the invention, the liner has at least one polyamide layer which is arranged between two ethylene copolymer layers.

Polyamides are linear polymers with regularly repeating amide bonds along the main chain. The amide group is a condensation product of a carboxylic acid and an amine, which means that very different polyamides can be realized by selecting the carboxylic acid and the amine.

Polyamides have excellent strength and toughness, while also being able to block blowing agents such as pentane from passing through. For example, a PA 6 and/or a PA 6.6 and/or a PA 6.66 can be used for the polyamide layer according to the invention.

In a particularly favorable variant of the invention, the thickness of the polyamide layer is less than 50 μm, preferably less than 40 μm, in particular less than 30 μm and/or more than 5 μm, preferably more than 10 μm, in particular more than 15 μm. The polyamide layer can therefore be particularly thin and material-saving and at the same time provide effective protection against the blowing agent passing through. In particular, this can effectively prevent the formation of an explosive mixture outside the container.

The ethylene copolymer layer consists of an ethylene and at least one copolymer.

Ideally, the ethylene copolymer layer is formed from an ethylene and a vinyl acetate. Vinyl acetate is an organic chemical compound from the carboxylic acid ester group of substances. Ethylene vinyl acetate (EVA) is used for the targeted realization of a defined water vapour permeation through the liner.

In a favorable variant, the proportion of ethylene vinyl acetate (EVA) in the ethylene copolymer layer is more than 45% by weight, preferably more than 55% by weight, in particular more than 65% by weight and/or less than 90% by weight, preferably less than 85% by weight, in particular less than 80% by weight.

Advantageously, the proportion of vinyl acetate in the ethylene vinyl acetate is more than 10% by weight, preferably more than 13% by weight, in particular more than 16% by weight and/or less than 25% by weight, preferably less than 22% by weight, in particular less than 19% by weight. A low and defined water vapor permeation can be achieved within this weight proportion. The defined water vapor permeation ensures that the container, in particular the octabiner made of corrugated cardboard, is not soaked and could therefore lose stability and at the same time no moisture can accumulate inside the liner.

In a preferred variant of the invention, the proportion of vinyl acetate in the ethylene copolymer layer is more than 5% by weight, preferably more than 8% by weight, in particular more than 12% by weight and/or less than 35% by weight, preferably less than 30% by weight, in particular less than 25% by weight.

In an advantageous variant of the invention, the ethylene copolymer layer has a chalk compound, wherein the proportion of chalk compound is more than 5% by weight, preferably more than 10% by weight, in particular more than 15% by weight, and/or less than 40% by weight, preferably less than 35% by weight, in particular less than 30% by weight. This makes it possible to advantageously reduce the polymer content of the liner and at the same time to roll it up in webs without the individual film webs of the liner sticking together.

In an alternative variant of the invention, the ethylene copolymer layer could also have an antiblocking agent.

The filler content can be determined using known measurement methods such as ashing. A sample with a known weight is heated to a temperature at which the polymer thermally decomposes but the filler does not. For example, 560° C. has proven to be a good temperature for this. The sample weight is then measured again. The polymer content per square meter can be calculated using the difference between the weighed out and weighed in weight.

As an alternative to ashing, a TGA measurement is possible in which the weight of a sample is measured continuously during heating. This test method can also clearly differentiate between polymer and filler and allows the polymer content of the film to be determined.

Ideally, the proportion of chalk in the chalk compound is more than 30% by weight, preferably more than 40% by weight, in particular more than 50 % by weight and/or less than 90% by weight, preferably less than 80% by weight, in particular less than 70% by weight.

In a particularly advantageous variant of the invention, calcium carbonate (CaCO₃) is used in the chalk compound, preferably with an average particle size of 0.8 to 2.5 μm.

In a particularly favorable variant of the invention, the thickness of the ethylene copolymer layer is less than 45 μm, preferably less than 30 μm, in particular less than 15 μm and/or more than 3 μm, preferably more than 6 μm, in particular more than 9 μm. The ethylene copolymer layer is particularly thin and material-saving and enables defined water vapor permeation through the liner.

In a particularly promising variant of the invention, at least one ethylene copolymer layer has a permanent antistatic agent.

Advantageously, the proportion of permanent antistatic agent in the ethylene copolymer layer is more than 10% by weight, preferably more than 15% by weight, in particular more than 20% by weight and/or less than 60% by weight, preferably less than 50% by weight, in particular less than 40% by weight.

Preferably, at least the inner ethylene copolymer layer has a permanent antistatic agent. This means that the inner layer can be connected to an earth during filling and emptying of the granulate, which prevents dangerous electrostatic charging.

The safe prevention of an electrostatic charge ensures safety in particular in the event of a blowing agent such as pentane outgassing from the granulate, which can form an explosive mixture with air or the oxygen in the air and could be ignited by electrostatic sparking.

Preferably, the permanent antistatic agent, for example an ion phase™, consists of inherently dissipative polymers. These reduce the specific resistance of polymers, such as in the ethylene copolymer layers, and offer control and safety in the event of electrostatic problems. Such a permanent antistatic agent can be added during compounding and/or extrusion. These non-migrating additives do not move or migrate through or out of a polymer layer.

Ideally, the liner with the integrated permanent antistatic agent has a specific surface resistance according to DIN IEC 60093 with parallel contact electrodes of more than 10⁷Ω, preferably more than 10⁸Ω, in particular more than 10⁹Ω and/or less than 10¹⁴Ω, preferably less than 10¹³Ω, in particular less than 10¹²Ω. Electrostatic charging can thus be effectively avoided.

In a particularly advantageous variant of the invention, the liner has at least one bonding layer which is arranged between the polyamide layer and the ethylene copolymer layer.

Ideally, the polyamide layer is formed as a middle layer and is bounded on both sides by a bonding layer, which in turn is covered by an ethylene copolymer layer.

In a favorable variant, the proportion of ethylene vinyl acetate (EVA) in the bonding layer is more than 40% by weight, preferably more than 50% by weight, in particular more than 60% by weight and/or less than 90% by weight, preferably less than 85% by weight, in particular less than 80% by weight.

Advantageously, the proportion of vinyl acetate in the ethylene-vinyl acetate of the bonding layer is more than 10% by weight, preferably more than 13% by weight, in particular more than 16% by weight and/or less than 25% by weight, preferably less than 22% by weight, in particular less than 19% by weight. A low and defined water vapor permeation can be achieved within this weight proportion. The defined water vapor permeation ensures that the container, in particular the octabiner made of corrugated cardboard, does not become soaked and could therefore lose stability and at the same time no moisture can accumulate inside the liner.

In a preferred variant of the invention, the proportion of vinyl acetate in the bonding layer is more than 5% by weight, preferably more than 8% by weight, in particular more than 11% by weight and/or less than 30% by weight, preferably less than 25% by weight, in particular less than 15% by weight.

Advantageously, the bonding layer has a proportion of maleic anhydride-modified linear low-density polyethylene, wherein the proportion of maleic anhydride-modified linear low-density polyethylene is more than 5% by weight, preferably more than 10% by weight, in particular more than 20% by weight and/or less than 60% by weight, preferably less than 50% by weight, in particular less than 40% by weight. As a result, both the polyamide layer and the ethylene copolymer layer adhere particularly well to the bonding layer. As a result, a stable bond of the individual layers of the liner is achieved and dissolution effects of the individual layers are avoided.

In a particularly favorable variant of the invention, the thickness of the bonding layer is less than 20 μm, preferably less than 15 μm, in particular less than 10 μm and/or more than 1 μm, preferably more than 2.5 μm, in particular more than 4 μm. The bonding layer is particularly thin and material-saving and enables defined water vapor permeation through the liner.

The special design of a preferably five-layer liner results in a film which has a gas transmission rate for the blowing agent according to DIN 53380 of less than 5 g/m²·day, preferably of less than 1 g/m²·day, in particular of less than 0.1 g/m²·day, measured at 38° C. and 50% RH. This ensures that the penetration of the blowing agent pentane is prevented.

Depending on the design of the granulate or plastic granulate that is surrounded and encased by the liner in the container, a blowing agent may outgas. In the case of expanded polystyrene, such a blowing agent can be pentane, which can form an explosive mixture together with the oxygen in the air. Avoiding explosive mixtures is extremely important for safe storage and/or safe transportation of the granules in a container. For this purpose, the liner according to the invention provides an effective blowing agent barrier and/or pentane barrier.

ASTM F1249 describes a method in which an infrared detector is used to measure water vapor permeability. The water vapor permeability is specified in g/m²·day. The relative humidity can be set up to 100% and is an important comparison factor alongside the temperature. As the infrared detector is a “relative measuring system”, a calibration must be carried out during the measuring cycle with films whose permeability values are known.

Advantageously, the liner has a water vapor permeation according to ASTM F1249 of less than 50 g/m²·day, preferably of less than 35 g/m²·day, in particular of less than 20 g/m²·day and/or of more than 5 g/m²·day, preferably of more than 8 g/m²·day, in particular of more than 11 g/m²·day, measured at 23° C. and 85% RH.

After the production of plastic granulate, water vapor escapes for a certain period of time. For this reason, a liner that allows water vapor to escape from the inside to the outside is advantageous. However, the amount escaping should be so small that a container surrounding the liner, for example made of corrugated cardboard, does not become soaked. At the same time, however, the water vapor permeation should be so high that no puddles of moisture form inside the liner. The liner according to the invention can achieve both with the aid of the special design and a clearly defined vinyl acetate content.

Preferably, the liner has at least five layers, which are preferably mirror-symmetrical to one another

In alternative variants, the liner can also have seven or nine layers. Preferably, one or two intermediate layers are arranged between the ethylene copolymer layer and the bonding layer. These intermediate layers are free of a chalk compound and a permanent antistatic agent and consist largely of ethylene vinyl acetate (EVA). In a particularly favorable variant of the invention, the thickness of the intermediate layer is less than 20 μm, preferably less than 15 μm, in particular less than 10 μm and/or more than 3 μm, preferably more than 5 μm, in particular more than 8 μm. In a preferred variant of the invention, the proportion of vinyl acetate in the intermediate layer is more than 5% by weight, preferably more than 8% by weight, in particular more than 11% by weight and/or less than 30% by weight, preferably less than 25% by weight, in particular less than 15% by weight.

In a preferred variant of the invention, the liner has a fracture life according to DIN EN 55445 of more than 0.25 h, preferably more than 0.5 h, in particular more than 0.75 h, at 50% stock.

Films and sheets with a thickness of up to 1 mm are tested using strip or shoulder samples. According to ISO 527-3 and ASTM D 882, the usual specimen shape is the strip. This sample shape can be produced easily using a cutting press or a film cutter. Shoulder samples are often used in quality control. In this case, a direct measuring extensometer is required, with which the sample elongations can be recorded directly on the sample. Typical test results such as the yield stress, the elongation at yield, the maximum stress and the nominal elongation at break are recorded.

The tensile properties are determined in accordance with DIN EN ISO 527. In the tensile test, a test strip of a liner is stretched at a constant speed specified in the test standard and the force F is recorded with the change in lengthΔ L of the measuring section L₍₀₎.

Ideally, the liner has a tensile strength in the machine direction according to DIN EN ISO 527-3 of more than 40 MPa, preferably more than 50 MPa, in particular more than 60 MPa.

In an advantageous variant of the invention, the liner has a tensile strength transverse to the machine direction according to DIN EN ISO 527-3 of more than 45 MPa, preferably more than 55 MPa, in particular more than 65 MPa.

The measurement of the thickness of the liner was determined in accordance with DIN 53370 and given as an average value. In a preferred variant of the invention, the liner has a thickness of less than 200 μm, preferably less than 160 μm, in particular less than 120 μm and/or more than 20 μm, preferably more than 30 μm, in particular more than 40 μm. The particular combination of the preferably five layers of the liner and the particular selection of polymers produces a very thin and material-saving film that can nevertheless withstand the mechanical stresses of filling, storing and emptying the granules in an octabin container.

In a particularly advantageous variant of the invention, the thickness of the liner is 50 μm.

A particularly obvious example of a plastic granulate is expandable polystyrene (EPS). This belongs to the group of organic, synthetic insulating materials. EPS insulation materials are mostly used for applications in the construction sector.

The finished plastic is usually sold as granules. In the case of expandable polystyrene, gases are trapped during polymerization into solid beads. The plastic pellets, or plastic granules, are transported in octabins for further processing. If the beads are heated there under steam to slightly above 100° C., the gas expands and the thermoplastic plastic inflates. The edges of the bubbles fuse together. The result is a molded solid that can be shaped.

According to the invention, the liner of the container is produced in a process comprising several steps. First, the polymer mixtures of the ethylene copolymer layers, the bonding layers and the polyamide layer are produced and provided. The polymer blends are melted and coextruded to form a liner film web, with the polyamide layer being formed as the inner layer. The film web is made up and welded to form a liner, which can then be placed in an octabin container.

According to the invention, the liner is used as an electrostatically dissipative and/or blowing agent-blocking inner pocket for octabin containers.

The special combination of selected polymers and the material-saving design result in a liner that can leave outgassing blowing agents, such as pentane, inside the liner and at the same time safely dissipate any charges that arise during the filling, transportation, storage or emptying of granulate, in particular plastic granulate. In addition, despite the particularly thin design and due to the special combination of materials, the liner can withstand the mechanical loads during the filling and transportation of plastic granules.

### BRIEF DESCRIPTION OF THE DRAWINGS

Further advantages and features of the invention are apparent from the description of an embodiment example with reference to drawings and from the drawings themselves. This shows

FIG. 1 a sketch of an octabin container,

FIG. 2 a schematic representation of the liner structure, and

FIG. 3 a further variant of the schematic representation of the liner structure.

### DETAILED DESCRIPTION

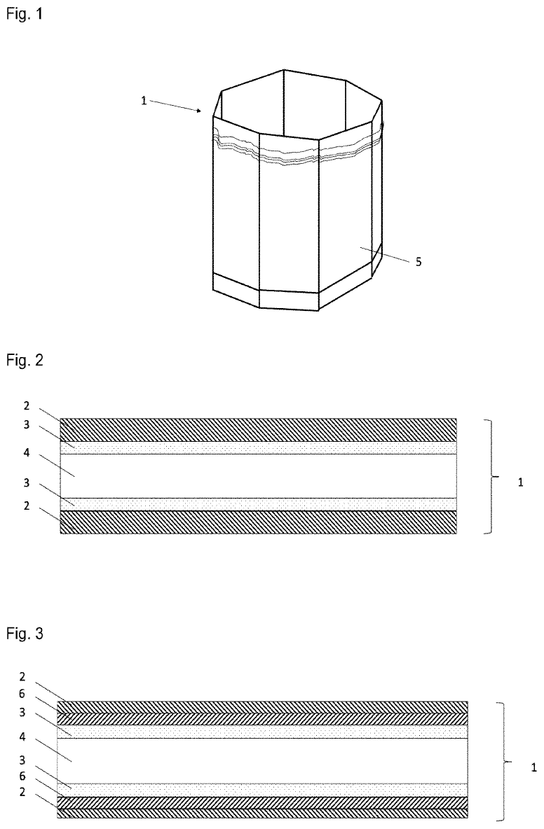

FIG. 1 shows a commercially available octabin 5 as used for the transportation and storage of plastic pellets, for example. A liner 1 in the form of an inner pocket is inserted into the octabin 5, which is usually made of corrugated cardboard, and can then be filled with the granulate. The liner 1 can be closed after filling and the octabin 5 can be closed with a lid or cover. This means that the octabins 5, which are usually placed on pallets, are also suitable for stacking.

FIG. 2 shows a schematic representation of the structure of the liner 1. The five-layer liner 1 comprises an inner polyamide layer 4, which in this embodiment is made of a PA 6.6 and has a thickness of 20 μm. The polyamide layer 4 is surrounded by two bonding layers 3, which have a thickness of 5 μm. In the embodiment shown, the bonding layer 3 consists of 30% by weight Bondyram TL4110 and 70% by weight ethylene vinyl acetate with a proportion of vinyl acetate of 17% by weight.

The outer layers are each formed by an ethylene copolymer layer 2, which has a thickness of 10 μm. The ethylene copolymer layer 2 comprises a proportion of ethylene vinyl acetate of 55% by weight with a proportion of vinyl acetate of 17% by weight, a chalk compound of 25% by weight with a proportion of chalk of 60% by weight and ion phase™ with a proportion of 25% by weight.

The liner 1 has a gas permeation rate for the blowing agent pentane according to DIN 53380 of less than 0.1 g/m²·day, while the water vapor permeation according to ASTM F1249 is less than 20 g/m²·day and/or more than 11 g/m²·day. The liner 1 has a surface resistance according to DIN IEC 60093 of more than 10⁷Ω and/or less than 10¹²Ω.

The illustration in FIG. 3 largely corresponds to the illustration in FIG. 2. However, the liner 1 has a seven-layer structure. The outer layers are each formed by an ethylene copolymer layer 2, which has a thickness of 4 μm. The ethylene copolymer layer 2 comprises a proportion of ethylene vinyl acetate of 55% by weight with a proportion of vinyl acetate of 17% by weight, a chalk compound of 25% by weight with a proportion of chalk of 60% by weight and ion phase™ with a proportion of 25% by weight.

An intermediate layer 6 is arranged between the outer layer and the bonding layer 3. The intermediate layer 6 comprises an ethylene vinyl acetate with a vinyl acetate content of 17% by weight and has a thickness of 6 μm.

1. A liner (1) for a container (5) for holding a granulate containing a blowing agent,
the liner (1) comprising:
two ethylene copolymer layers (2), and
at least a polyamide layer (4) arranged between the two ethylene copolymer layers (2).

2. The liner according to claim 1, wherein the ethylene copolymer layer (2) is formed from an ethylene and a vinyl acetate.

3. The liner according to claim 2, wherein a proportion of the vinyl acetate in the ethylene copolymer layer (2) is more than 5% by weight and is less than 35% by weight.

4. The liner according to claim 1, wherein the polyamide layer (4) is formed from a copolyamide 6.66.

5. The liner according to claim 1, wherein the liner has at least a bonding layer (3), which is arranged between the polyamide layer and at least one of the ethylene copolymer layers (2).

6. The liner according to claim 5, wherein the bonding layer (3) has a proportion of the vinyl acetate, the proportion of vinyl acetate being more than 5% by weight and less than 30% by weight.

7. The liner according to claim 5, wherein the bonding layer (3) has a proportion of maleic anhydride-modified linear low-density polyethylene, the proportion of maleic anhydride-modified linear low-density polyethylene being more than 5% by weight and less than 60% by weight.

8. The liner according to claim 1, wherein the ethylene copolymer layer (2) comprises a chalk compound, a proportion of chalk compound being more than 5% by weight and less than 40% by weight.

9. The liner according to claim 8, wherein a proportion of chalk in the chalk compound is more than 30 % by weight and less than 90 % by weight.

10. The liner according to claim 1, wherein the at least one ethylene copolymer layer (2) comprises a permanent antistatic agent, a proportion of the permanent antistatic agent being more than 10% by weight and less than 60% by weight.

11. The liner according to claim 1, wherein the liner (1) has a gas transmission rate for the blowing agent according to DIN 53380 of less than 5 g/m²·day measured at 38° C. and 50% RH.

12. The liner according to claim 1, wherein the liner (1) has a water vapour permeation according to ASTM F1249 of less than 50 g/m²·day and of more than 5 g/m²·day measured at 23° C. and 85% RH.

13. The liner according to claim 1, wherein the liner (1) has at least five layers, which are formed mirror-symmetrically to one another.

14. The liner according to claim 1, wherein the liner (1) has a fracture life according to DIN EN 55445 at 50% stock of more than 0.25 h.

15. The liner according to claim 1, wherein the liner (1) has a tensile strength in a machine direction according to DIN EN ISO 527-3 of more than 40 MPa.

16. The liner according to claim 1, wherein the liner (1) has a surface resistance according to DIN IEC 60093 of more than 10⁷Ωand of less than 10¹⁴Ω.

17. The liner according to claim 1, wherein the liner (1) has a thickness of less than 200 μm and more than 20 μm.

18. A method of manufacturing a liner (1) comprising the following steps:
preparing and producing various polymer mixtures,
coextruding a polyamide layer (4) with two ethylene copolymer layers (2), the polyamide layer (4) being arranged between the two ethylene copolymer layers (2), and the bonding layers (3) being arranged between the polyamide layer (4) and the two ethylene copolymer layers (2), to form a liner (1),
wherein the polyamide layer (4) is formed as an innermost layer.

19. The method of claim 18, further comprising using the liner (1) as an electrostatically dissipative and blowing agent-blocking inner pocket for octabin containers.
